(19) United States
(12) Patent Application Publication
(10) Pub. No.: US 2025/0322276 A1
(43) Pub. Date: Oct. 16, 2025

(54) MODEL INTERPRETABILITY INFORMATION GENERATION

(71) Applicant: Tencent Technology (Shenzhen) Company Limited, Shenzhen (CN)

(72) Inventor: Yue LIN, Shenzhen (CN)

(73) Assignee: Tencent Technology (Shenzhen) Company Limited, Shenzhen, GD (CN)

(21) Appl. No.: 19/248,336

(22) Filed: Jun. 24, 2025

Related U.S. Application Data
(63) Continuation of application No. PCT/CN2024/079817, filed on Mar. 4, 2024.

(30) Foreign Application Priority Data
Apr. 23, 2023 (CN) 202310446624.5

(51) Int. Cl. G06N 5/045

(52) U.S. Cl. CPC G06N 5/045

(57) ABSTRACT

In a model interpretability information generation method, respective first parameters of a plurality of local features are determined based on the plurality of local features and a target category of a multimedia resource, the target category being obtained through prediction on the multimedia resource by a first model. Respective paths of the plurality of local features are determined based on the plurality of local features and the target category, a starting point of a path of a local feature of the plurality of local features representing the local feature, an end point representing the target category, and the path representing a processing process of obtaining the target category based on the local feature. Based on the respective first parameters and the paths of the plurality of local features, model interpretability information of a process of obtaining the target category by the first model based on the multimedia resource is generated.

### RELATED APPLICATIONS

The present application is a continuation of International Application No. PCT/CN2024/079817, filed on Mar. 4, 2024, which claims priority to Chinese Patent Application No. 202310446624.5, entitled “MODEL INTERPRETABILITY INFORMATION GENERATION METHOD AND APPARATUS, COMPUTER DEVICE, AND STORAGE MEDIUM” and filed on Apr. 23, 2023, which are hereby incorporated by reference in their entirety.

### FIELD OF THE TECHNOLOGY

This disclosure relates to the field of computer technologies, including to a model interpretability information generation method and apparatus, a computer device, and a storage medium.

### BACKGROUND OF THE DISCLOSURE

With development of computer technologies, machine learning models are more widely applied. For example, in the field of finance, a financial product marketing model outputs a credit score, a marketing success probability, and the like of a user based on inputted user information.

### SUMMARY

Embodiments of this disclosure provide a model interpretability information generation method and apparatus, a computer device, and a storage medium, so that more accurate and detailed model interpretability information can be generated, to improve credibility and reliability of model interpretation. Technical solutions include the following:

According to an aspect, in a model interpretability information generation method, respective first parameters of a plurality of local features are determined based on the plurality of local features and a target category of a multimedia resource, the target category being obtained through prediction on the multimedia resource by a first model, and the first parameters indicating degrees of contribution of the plurality of local features to the target category. Respective paths of the plurality of local features are determined based on the plurality of local features and the target category, a starting point of a path of a local feature of the plurality of local features representing the local feature, an end point representing the target category, and the path representing a processing process of obtaining the target category based on the local feature. Based on the respective first parameters and the paths of the plurality of local features, model interpretability information of a process of obtaining the target category by the first model based on the multimedia resource is generated.

According to an aspect, an information processing apparatus including processing circuitry is provided. The processing circuitry configured to determine respective first parameters of a plurality of local features based on the plurality of local features and a target category of a multimedia resource, the target category being obtained through prediction on the multimedia resource by a first model, and the first parameters indicating degrees of contribution of the plurality of local features to the target category. The processing circuitry is configured to determine respective paths of the plurality of local features based on the plurality of local features and the target category, a starting point of a path of a local feature of the plurality of local features representing the local feature, an end point representing the target category, and the path representing a processing process of obtaining the target category based on the local feature. The processing circuitry is configured to generate, based on the respective first parameters and the paths of the plurality of local features, model interpretability information of a process of obtaining the target category by the first model based on the multimedia resource.

According to an aspect, a non-transitory computer-readable storage medium is provided. The non-transitory computer-readable storage medium stores instructions which when executed by a processor cause the processor to determine respective first parameters of a plurality of local features based on the plurality of local features and a target category of a multimedia resource, the target category being obtained through prediction on the multimedia resource by a first model, and the first parameters indicating degrees of contribution of the plurality of local features to the target category. The instructions when executed by the processor cause the processor to determine respective paths of the plurality of local features based on the plurality of local features and the target category, a starting point of a path of a local feature of the plurality of local features representing the local feature, an end point representing the target category, and the path representing a processing process of obtaining the target category based on the local feature. The instructions when executed by the processor cause the processor to generate, based on the respective first parameters and the paths of the plurality of local features, model interpretability information of a process of obtaining the target category by the first model based on the multimedia resource.

According to an aspect, a model interpretability information generation method is provided, the method including: determining respective first parameters of a plurality of local features based on the plurality of local features and a target category of a multimedia resource, the target category being obtained through prediction on the multimedia resource by a first model, the first model being configured to predict a category of an inputted multimedia resource, and a first parameter of one local feature being configured for indicating a degree of contribution of the local feature to the target category; determining respective paths of the plurality of local features based on the plurality of local features and the target category, a starting point of a path of one local feature being configured for representing the local feature, an end point being configured for representing the target category, and the path being configured for representing a processing process of obtaining the target category based on the local feature; and generating model interpretability information of the first model based on the respective first parameters and paths of the plurality of local features, the model interpretability information being configured for interpreting a process of obtaining the target category by the first model based on the multimedia resource.

According to another aspect, a model interpretability information generation apparatus is provided, the apparatus including: a first determining module, configured to determine respective first parameters of a plurality of local features based on the plurality of local features and a target category of a multimedia resource, the target category being obtained through prediction on the multimedia resource by a first model, the first model being configured to predict a category of an inputted multimedia resource, and a first parameter of one local feature being configured for indicating a degree of contribution of the local feature to the target category; a second determining module, configured to determine respective paths of the plurality of local features based on the plurality of local features and the target category, a starting point of a path of one local feature being configured for representing the local feature, an end point being configured for representing the target category, and the path being configured for representing a processing process of obtaining the target category based on the local feature; and a first generation module, configured to generate model interpretability information of the first model based on the respective first parameters and paths of the plurality of local features, the model interpretability information being configured for interpreting a process of obtaining the target category by the first model based on the multimedia resource.

According to another aspect, a computer device is provided. The computer device includes a processor and a memory, the memory being configured to store at least one computer program, and the at least one computer program being loaded and executed by the processor to perform the model interpretability information generation method in the embodiments of this disclosure.

According to another aspect, a non-transitory computer-readable storage medium is provided, having at least one computer program stored therein, the at least one computer program when executed by a processor cause the processor to perform the model interpretability information generation method in the embodiments of this disclosure.

According to another aspect, a computer program product is provided, including a computer program, the computer program being executed by a processor to perform the model interpretability information generation method provided in the embodiments of this disclosure.

### BRIEF DESCRIPTION OF THE DISCLOSURE

To describe the technical solutions in embodiments of this disclosure more clearly, the following briefly describes the accompanying drawings.

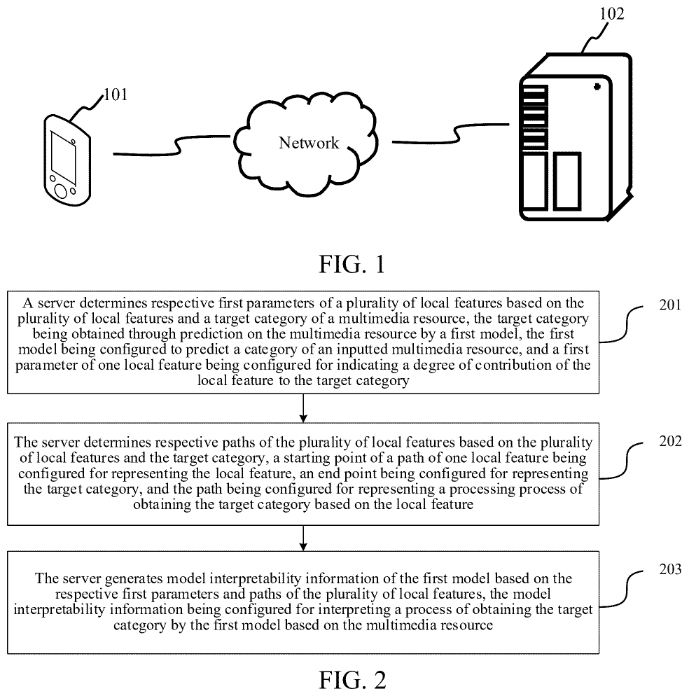

FIG. 1 is a schematic diagram of an implementation environment of a model interpretability information generation method according to an embodiment of this disclosure.

FIG. 2 is a flowchart of a model interpretability information generation method according to an embodiment of this disclosure.

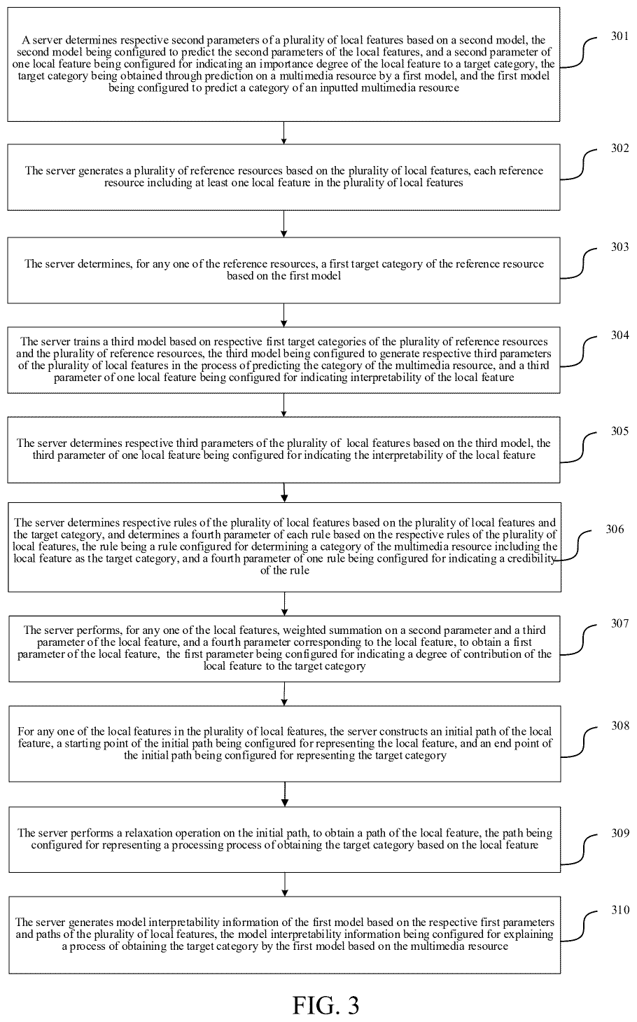

FIG. 3 is a flowchart of another model interpretability information generation method according to an embodiment of this disclosure.

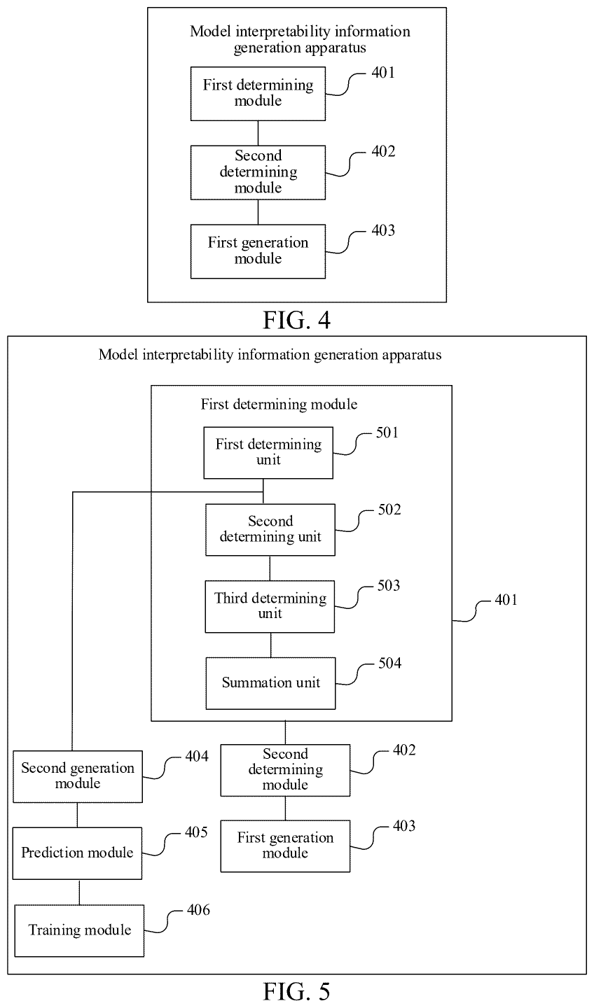

FIG. 4 is a block diagram of a model interpretability information generation apparatus according to an embodiment of this disclosure.

FIG. 5 is a block diagram of another model interpretability information generation apparatus according to an embodiment of this disclosure.

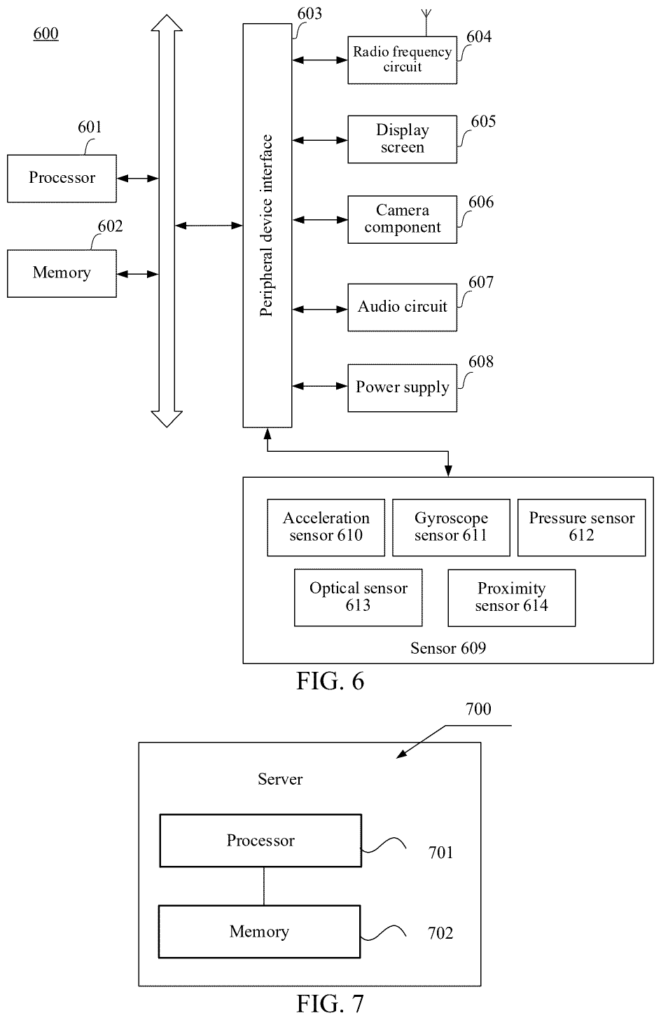

FIG. 6 is a structural block diagram of a terminal according to an embodiment of this disclosure.

FIG. 7 is a schematic structural diagram of a server according to an embodiment of this disclosure.

### DESCRIPTION OF EMBODIMENTS

In order to make the objectives, technical solutions, and advantages of this disclosure clearer, the following further describes implementations of this disclosure in with reference to the accompanying drawings.

In this disclosure, the terms such as “first” and “second” are used to distinguish between same items or similar items with substantially same effects and functions. It is to be understood that “first”, “second”, and “n^{th}” do not have a dependency relationship in logic or time sequence, and a quantity and an execution order are not limited.

In this disclosure, the term “at least one” means one or more, and “a plurality of” means two or more.

Because of a black-box characteristic of a complex machine learning model, for a user, the machine learning model feeds back only a decision result according to an input, but a decision-making process and a decision-making basis are not transparent for the user, thereby reducing reliability of the machine learning model. Therefore, how to explain the decision-making process and the decision-making basis of the machine learning model to improve the reliability of the machine learning model is a technical problem to be resolved.

In the related art, to understand the decision-making process and the decision-making basis of the machine learning model, a prediction of a black-box model (i.e., a complex machine learning model) can be approximated by training an interpretable model (such as a linear regression model, a decision tree model, or a logistic regression model). First, a trained black-box model is configured to predict a data set, and then an interpretable model is trained according to the data set and a prediction result of the black-box model, so that a decision-making process and a decision-making basis of the black-box model can be explained by using a trained interpretable model.

However, the solution described above can only provide a relatively simple model interpretation, and cannot satisfy a requirement of the complex machine learning model, resulting in low reliability of the complex machine learning model.

Terms involved in this disclosure are explained below. The descriptions of the terms are provided as examples only and are not intended to limit the scope of the disclosure.

Artificial intelligence (AI): A theory, a method, a technology, and an application system that use a digital computer or a machine controlled by a digital computer to simulate, extend, and expand human intelligence, sense an environment, acquire knowledge, and obtain an optimal category by using the knowledge. In other words, an artificial intelligence is a comprehensive technology in computer science and attempts to understand the essence of intelligence and produce a new intelligent machine that can react in a manner similar to human intelligence. The artificial intelligence is to study design principles and implementation methods of various intelligent machines, to enable the machines to have functions of perception, reasoning, and decision-making.

An artificial intelligence technology is a comprehensive discipline, covering a wide range of fields including both a hardware-level technology and a software-level technology. A basic artificial intelligence technology generally includes technologies such as a sensor, a dedicated artificial intelligence chip, cloud computing, distributed storage, a big data processing technology, an operating/interaction system, and electromechanical integration. An artificial intelligence software technology mainly includes several major directions such as a computer vision technology, a speech processing technology, a natural language processing technology, and machine learning/deep learning, autonomous driving, and intelligent transportation.

Machine learning (ML): Machine learning is a multi-field interdiscipline, and relates to a plurality of disciplines such as probability theory, statistics, approximation theory, convex analysis, and algorithm complexity theory. In the machine learning, how a computer simulates or implements a human learning behavior is specifically studied, to obtain new knowledge or a new skill, and reorganize an existing knowledge structure, so that performance of the computer is continuously improved. The machine learning is the core of artificial intelligence and a fundamental way to make computers intelligent, and is applied to various fields of the artificial intelligence. The machine learning and deep learning generally include technologies such as an artificial neural network, a belief network, reinforcement learning, transfer learning, inductive learning, and learning from demonstration.

Explainability: Explainability means that an output of a machine learning model can be understood and explained, so that humans can understand what does the model do and how to perform prediction.

Critical path analysis: Critical path analysis means that in a complex system, a most important path affecting the entire system is found to perform system optimization.

A model interpretability information generation method provided in embodiments of this disclosure can be performed by a computer device. In some embodiments, the computer device is a terminal or a server. An implementation environment of the model interpretability information generation method according to an embodiment of this disclosure is described below by using an example in which the computer device is a server. FIG. 1 is a schematic diagram of an implementation environment of a model interpretability information generation method according to an embodiment of this disclosure. As shown in FIG. 1, the implementation environment includes a terminal 101 and a server 102. The terminal 101 and the server 102 are directly or indirectly connected in a wired or wireless communication manner. This is not limited in this disclosure.

In some embodiments, the terminal 101 is a smart phone, a tablet computer, a notebook computer, a desktop computer, a smart speaker, a smart watch, a smart voice interactive device, a smart household appliance, or an on-board terminal, but is not limited thereto. An application that can display model interpretability information of a first model is installed on the terminal 101. In some embodiments, the application is a social application, a financial application, an information application, or the like. This is not limited in this embodiment of this disclosure. In an example, the application is a financial application, and the first model is a credit evaluation model, so that the financial application can obtain a credit score of a user according to user information based on the credit evaluation model. To understand how the credit evaluation model obtains the credit score of the user according to the user information, the terminal 101 can transmit the credit evaluation model to the server 102, and the server 102 analyzes a processing process in which the credit evaluation model obtains the credit score of the user according to the user information.

In some embodiments, the server 102 is an independent physical server, or can be a server cluster including a plurality of physical servers or a distributed system, or can further be a cloud server providing basic cloud computing services such as a cloud service, a cloud database, cloud computing, a cloud function, cloud storage, a network service, cloud communication, a middleware service, a domain name service, a security service, a content delivery network (CDN), a big data and an artificial intelligence platform. The server 102 is configured to provide a backend service for the application collected by the foregoing content items for support. In an example, the server 102 receives the credit evaluation model uploaded by the terminal 101. The server 102 can perform, based on a plurality of user features of the user information and the credit score of the user, parsable analysis and critical path analysis on the credit evaluation model, to obtain model interpretability information of the credit evaluation model. The server 102 returns the model interpretability information to the terminal 101, and the terminal 101 displays the model interpretability information by using the application.

In some embodiments, the server 102 is in charge of primary computing works, and the terminal 101 is in charge of secondary computing works; alternatively, the server 102 is in charge of the secondary computing works, and the terminal 101 is in charge of the primary computing works; and alternatively, the server 102 and the terminal 101 perform collaborative computing by using a distributed computing architecture.

FIG. 2 is a flowchart of a model interpretability information generation method according to an embodiment of this disclosure. As shown in FIG. 2, in this embodiment of this disclosure, descriptions are given by using an example in which the method is performed by a server. The model interpretability information generation method includes the following operations:

201: The server determines respective first parameters of a plurality of local features based on the plurality of local features and a target category of a multimedia resource, the target category being obtained through prediction on the multimedia resource by a first model, the first model being configured to predict a category of an inputted multimedia resource, and a first parameter of one local feature being configured for indicating a degree of contribution of the local feature to the target category.

In this embodiment of this disclosure, the multimedia resource is a text, an image, a video, audio, or the like. This is not limited in this embodiment of this disclosure. For example, when the multimedia resource is an image, the first model is an image recognition model, and the image recognition model is configured to predict a category of an inputted image. In some embodiments, the category of the image includes an animal category, a plant category, a building category, and the like. When the multimedia resource is a video, the first model is a video recognition model, and the video recognition model may be configured to predict a category of an inputted video. In some embodiments, the category of the video includes a game category, a sports category, a scenery category, and the like. The server performs interpretability analysis on the first model based on the plurality of local features and the target category of the multimedia resource, to obtain the respective first parameters of the plurality of local features of the multimedia resource. Each first parameter is configured for indicating a degree of contribution of a local feature to the target category. The category obtained through the prediction by the first model is the target category because of impact of the local feature. The first parameter of the local feature represents impact of the local feature. A larger first parameter indicates a larger degree of contribution of the local feature to the target category, in other words, a larger first parameter indicates greater impact of the local feature when the first model obtains the target category. Therefore, by analyzing the respective first parameters of the plurality of local features, it may be determined that a local feature with a larger first parameter is a feature used by the first model when obtaining the target category based on the multimedia resource, and a local feature with a smaller first parameter is not a local feature used by the first model when obtaining the target category based on the multimedia resource, to help a user learn a decision-making basis based on which the first model obtains the target category.

In this embodiment of this disclosure, because the first parameter is configured for indicating the degree of contribution of the local feature to the target category, the first parameter can also be referred to as “interpretability”. A processing process of operation 201 can be referred to as “interpretability analysis on the first model”.

202: The server determines respective paths of the plurality of local features based on the plurality of local features and the target category, a starting point of a path of one local feature being configured for representing the local feature, an end point being configured for representing the target category, and the path being configured for representing a processing process of obtaining the target category based on the local feature.

In this embodiment of this disclosure, because the first model can output the target category of the multimedia resource based on the inputted multimedia resource, the server can determine the respective paths of the plurality of local features based on the plurality of local features and the target category of the multimedia resource. Each path includes a plurality of nodes, a starting point of the path is configured for representing a local feature of the multimedia resource, and an end point is configured for representing the target category of the multimedia resource. The server can determine, based on a connection relationship between the plurality of nodes in the path, a processing process of obtaining the target category represented by using the end point based on the local feature represented by using the starting point.

Because the path is a path from the local feature to the target category, therefore, the path also represents that the first model obtains the target category by performing processing by using the local feature. Therefore, the path can represent a processing process of obtaining the target category based on the local feature.

In some embodiments, the path is a path in feature space. There are a plurality of nodes in the feature space. Each node respectively represents a feature, and a plurality of features represented by the plurality of nodes include a plurality of local features and respective features of a plurality of categories. Correspondingly, a path of each local feature is a path starting from a node representing the local feature, passing a plurality of intermediate nodes, and reaching a node representing a feature of the target category. The plurality of intermediate nodes are intermediate variables obtained by processing the local features by the first model.

In some embodiments, when determining a path of a local feature, the server first determines two nodes respectively representing the local feature and the target category, and then determines a node between the two nodes, to determine the path of the local feature.

The feature space is any feature space created by the server, and any one of the local features or any one of the categories may be mapped to the feature space, to obtain a feature of the any one of the local features or a feature of the any one of the categories.

In this embodiment of this disclosure, because the path is a path in the feature space, the path can be referred to as a “feature path”. A processing process of operation 202 can be referred to as “critical path analysis on the first model”.

203: The server generates model interpretability information of the first model based on the respective first parameters and paths of the plurality of local features, the model interpretability information being configured for interpreting a process of obtaining the target category by the first model based on the multimedia resource.

In this embodiment of this disclosure, based on a plurality of first parameters, degrees of contribution of the plurality of local features to obtaining the target category by the first model respectively can be learned, so that specific local features based on which the first model determines the target category can be learned. In addition, a plurality of paths represent a process in which the first model obtains the target category based on the plurality of local features. Therefore, the server can generate the model interpretability information of the first model based on the respective first parameters and paths of the plurality of local features. In some embodiments, the model interpretability information is in a form of a table, a text, a picture, or the like. This is not limited in this embodiment of this disclosure. The server can interpret, by generating the model interpretability information of the first model, the process of obtaining the target category by the first model based on the multimedia resource, to help the user better understand a decision-making process of the first model. This improves credibility and reliability of model interpretation.

A larger first parameter of the local feature represents that the obtaining of the target category by the first model relies on the local feature to a larger extent. A shorter path of the local feature represents that determining the target category by the first model is most likely to be implemented based on the processing process represented by the path. Therefore, a local feature with a larger first parameter and/or a local feature with a shorter path can be selected based on values of the first parameters and lengths of the paths of the plurality of local features, to generate the model interpretability information.

In some embodiments, the model interpretability information includes one or more target local features, and the one or more target local features are local features selected from the plurality of local features of the multimedia resource, to interpret that the first model obtains the target category based on these target local features.

In an implementation, the plurality of local features of the multimedia resource are sorted in descending order of the first parameters, and first N local features are selected as the target local features, and/or the plurality of local features of the multimedia resource are sorted in descending order of the lengths of the paths, and first N local features are selected as the target local features, N being a positive integer greater than 1.

In another implementation, if a local feature with a largest first parameter and a shortest the path exists in the plurality of local features of the multimedia resource, the local feature is used as the target local feature.

In another implementation, the model interpretability information includes the respective first parameters and paths of the plurality of local features. By comparing the values of the first parameters of the plurality of local features in the model interpretability information, specific local features having more contribution in the process of determining the target category may be learned. By comparing the lengths of paths of the plurality of local features in the model interpretability information, specific local features that are simple in the process of determining the target category may be learned.

This embodiment of this disclosure provides a model interpretability information generation method. The respective first parameters and paths of the plurality of local features are determined based on the plurality of local features and the target category of the multimedia resource. Relationships between the plurality of local features and the target category can be determined based on the degrees of contribution, indicated by the plurality of first parameters, of the plurality of local features to the target category, and the processing process of obtaining the target category based on the local feature can be learned based on the paths. In this way, the model interpretability information of the first model is generated based on information of a plurality of dimensions of the plurality of local features, and the process of obtaining the target category by the first model based on the multimedia resource can be more accurately interpreted in detail based on the model interpretability information, thereby improving the credibility and the reliability of the model interpretation.

FIG. 3 is a flowchart of another model interpretability information generation method according to an embodiment of this disclosure. As shown in FIG. 3, in this embodiment of this disclosure, descriptions are given by using an example in which the method is performed by a server. The model interpretability information generation method includes the following operations:

301: The server determines respective second parameters of a plurality of local features based on a second model, the second model being configured to predict the second parameters of the local features, a second parameter of one local feature being configured for indicating an importance degree of the local feature to a target category, the target category being obtained through prediction on a multimedia resource by a first model, and the first model being configured to predict a category of an inputted multimedia resource.

In this embodiment of this disclosure, the multimedia resource is a text, an image, a video, audio, or the like. This is not limited in this embodiment of this disclosure. The server predicts the multimedia resource based on the first model, to obtain a target category of the multimedia resource. Using an example in which the multimedia resource is an image, a target category of the image may be an animal category, a plant category, a building category, or the like. The second model is a machine learning model obtained through training based on a plurality of sample multimedia resources. The second model can not only predict the category of the inputted multimedia resource, but also predict the second parameters of the plurality of local features of the multimedia resource in a prediction process. Therefore, the server predicts the plurality of local features based on the second model, to obtain the respective second parameters of the plurality of local features. The server can determine importance degrees of the plurality of local features to the target category based on a plurality of second parameters outputted by the second model. A larger second parameter indicates a greater importance degree of a local feature to the target category, and a closer relationship between a local feature and the target category indicates greater impact of the local feature when the target category is obtained by the first model.

In some embodiments, the first model is a convolutional neural network (CNN) model, and includes components of a convolutional layer, a pooling layer, and a fully-connected layer. Using an example in which the multimedia resource is an image, when the CNN model extracts a feature of the image, the image is first inputted into the convolutional layer, and a series of feature maps are obtained by performing a series of convolution operations and activation function calculation. Then, a downsampling operation is performed on the feature maps by using the pooling layer, to reduce sizes of the feature maps and improve calculation efficiency. Finally, an output of the pooling layer is used as an input of the fully-connected layer, and a task such as classification or regression is performed by using the fully-connected layer. An end-to-end training method is used for the CNN model. In some embodiments, a model parameter is optimized by using a back propagation algorithm, to improve accuracy and efficiency of the model. The server uses the CNN model as the first model. Because the CNN model can perform feature extraction on the multimedia resource in a process of predicting a category, a useful local feature can be automatically extracted from the multimedia resource through the first model, thereby improving accuracy and efficiency of the first model.

In some embodiments, the server performs a convolution operation on the inputted image by using Formula 1. The server represents an activation function of the first model by using Formula 2. The server performs, by using Formula 3, a pooling operation on the feature maps outputted by the convolutional layer.

$$S ( i , j ) = {\sum }_{m} {\sum }_{n} I ( i + m , j + n ) K ( m , n ) \qquad Formula 1$$

I(i+m,j+n) represents a pixel value of a pixel point in the inputted image whose horizontal coordinate is i+m and vertical coordinate is j+n, K represents a convolution kernel, and S(i,j) represents a convolution result of a pixel point whose horizontal coordinate is i and vertical coordinate is j. m represents a height of the convolution kernel K, n represents a width of the convolution kernel K, and i,j,m, and n are positive integers.

$${y}_{i} = f ( {z}_{i} ) = f ( {\sum }_{j} {w}_{ij} {x}_{j} + {b}_{i} ) \qquad Formula 2$$

wᵢⱼ represents a weight between an i^{th} neuron and a j^{th} neuron in the first model, xⱼ represents an input of the j^{th} neuron, bi represents an offset of the i^{th} neuron, zᵢ represents an input of the i^{th} neuron, ƒ represents an activation function, and yᵢ represents an output value of an activation function of the i^{th} neuron in the first model.

$${y}_{i , j} = {max}_{( p , q ) ∈ R ( i , j )} {x}_{p , q} \qquad Formula 3$$

x_{p,q} represents a pixel value of a pixel point (p,q) on an inputted feature map, R(i,j) represents a receptive field of a pixel point (i,j), and y_{i,j} represents a pooling result of the pixel point (i,j).

In some embodiments, the first model is obtained through training based on the plurality of sample multimedia resources. Before training the first model, the server can preprocess the plurality of sample multimedia resources. First, the server cleans the plurality of sample multimedia resources, to remove a sample multimedia resource having an abnormal condition such as noise or a missing value from the plurality of sample multimedia resources, so as to improve quality and accuracy of training data of the first model. Then, the server performs normalization on a plurality of sample multimedia resources obtained after cleaning, so that the plurality of sample multimedia resources can have a same metric scale, to improve a training effect of the model. The server performs the normalization on the plurality of sample multimedia resources by using Formula 4 or Formula 5, and an example in which the sample multimedia resources are images is used for description.

$${x}^{′} = \frac{x - min}{max - min} \qquad Formula 4$$

$${x}^{′} = \frac{x - μ}{σ} \qquad Formula 5$$

x represents a pixel value of any pixel point in the image; x′ represents a pixel value of the any pixel point obtained through normalization; min represents a minimum pixel value of a plurality of pixel points in the image; max represents a maximum pixel value of the plurality of pixel points in the image; μ represents an average value of pixel values of all pixel points in the image; and σ represents a standard deviation of the pixel values of all the pixel points in the image.

The server inputs the multimedia resource into the first model, so that not only the target category of the multimedia resource can be obtained, but also the plurality of local features of the multimedia resource can be obtained. In some embodiments, the plurality of local features are respectively vectors.

In some embodiments, the second model includes a plurality of decision trees. The server inputs the plurality of local features of the multimedia resource into the second model. The second model can not only predict the target category of the multimedia resource, but also obtain the respective second parameters of the plurality of local features based on the plurality of decision trees. Each second parameter is configured for indicating an importance degree of a local feature for the predicted target category. For any one of the local features, the server can determine a second parameter of the local feature based on the second parameters of the local features respectively in the plurality of decision trees. Correspondingly, for any one of the local features of the plurality of local features, second parameters of the local feature in all decision trees are determined based on the second model; and an average value of the second parameters of the local feature in all the decision trees is determined as the second parameter of the local feature. The second model includes a plurality of mutually independent decision trees. For any one of the decision trees, the server can input the plurality of local features into the decision tree, to obtain the second parameters of the plurality of local features respectively in the decision tree. Therefore, the server can obtain, for any one of the local features, a second parameter of the local feature in each decision tree based on the plurality of decision trees of the second model, that is, obtain an importance degree of the local feature to the target category in each decision tree of the second model. The server can determine an average value of the second parameters of the local feature in the plurality of decision trees as the second parameter of the local feature. In this embodiment, the second parameter of the local feature is obtained by integrating the second parameters of the local feature in the plurality of decision trees, to improve accuracy of the second parameter of the local feature.

In some embodiments, the second model is obtained through training based on the plurality of sample multimedia resources and respective target categories of the plurality of sample multimedia resources, and the respective target categories of the plurality of sample multimedia resources are obtained through the prediction based on the first model. In this way, the second model is trained by using a category predicted by the first model as a target, to obtain the second model approximate to the first model, so that a category predicted by the second model is the same as the category predicted by the first model.

In some embodiments, the second model is a random forest model, and the server can determine the respective second parameters of the plurality of local features by using Formula 6.

$${FI}_{j} = \frac{{\sum }_{t ∈ T} I ( j ∈ {T}_{t} ) p ( t )}{{\sum }_{t ∈ T} p ( t )} \qquad Formula 6$$

FIⱼ represents a second parameter of a j^{th} local feature; T represents a decision tree set, and Tₜ represents a t^{th} decision tree; I(j∈Tₜ) represents a second parameter of the j^{th} local feature in the t^{th} decision tree; and p(t) represents a sample proportion of the t^{th} decision tree, t being a positive integer greater than 1.

In some embodiments, the second model is a gradient boosting decision tree model, and the server can determine the respective second parameters of the plurality of local features by using Formula 7.

$${FI}_{j} = {\sum }_{t = 1}^{T} \frac{p ( j ∈ {T}_{t} ) {L}_{t}}{{\sum }_{k = 1}^{K} p ( k ∈ {T}_{t} ) {L}_{t}} \qquad Formula 7$$

FIⱼ represents a second parameter of a j^{th} local feature; T represents a decision tree set, and Tₜ represents a t^{th} decision tree; Lₜ represents a loss function of the t^{th} decision tree; and p(j∈Tₜ) represents a second parameter of the j^{th} local feature in the t^{th} decision tree, and p(k∈Tₜ) represents a second parameter of a k^{th} feature in the t^{th} decision tree.

In this embodiment of this disclosure, because the second model is configured to predict a category and a second parameter, the second model can also be referred to as a “prediction model”. Because the second parameter is configured for indicating an importance degree of a local feature to the target category, the second parameter can also be referred to as an “importance degree”. A processing process of operation 301 can be referred to as “performing importance analysis on the plurality of local features”.

302: The server generates a plurality of reference resources based on the plurality of local features, each reference resource including at least one local feature in the plurality of local features.

The server performs random sampling on the plurality of local features for a plurality of times, and obtains at least one local feature through each time of sampling. For any time of sampling, a multimedia resource including the at least one local feature is generated, and the multimedia resource is used as a reference resource. In addition to the at least one local feature, the reference resource can further include another feature or not include another features. Because the reference resource and the original multimedia resource may have a same local feature, or may have different local features, the reference resource can serve as a reference.

In this embodiment of this disclosure, in a process of performing the random sampling on the plurality of local features of the multimedia resource, the server can randomly select at least one local feature from the plurality of local features, and the server generates a reference resource based on the at least one local feature obtained through sampling. The reference resource is similar to the multimedia resource. More local features included in the reference resource indicates a higher similarity degree with the multimedia resource. The server can obtain the plurality of reference resources similar to the multimedia resource by performing the random sampling on the plurality of local features for the plurality of times. In some embodiments, the server performs the random sampling on the plurality of local features in a manner such as Gaussian distribution or uniform distribution.

The reference resource is a multimedia resource adjusted based on the original multimedia resource, and can also be referred to as a “disturbance multimedia resource”.

303: The server determines, for any one of the reference resources, a first target category of the reference resource based on the first model.

In this embodiment of this disclosure, the first model is configured to predict the category of the inputted multimedia resource. The server can determine a first target category of each reference resource based on the first model. In other words, for any one of the reference resources, the reference resource is inputted into the first model, and the first model outputs a category of the reference resource. The category is referred to as the first target category.

304: The server trains the third model based on respective first target categories of the plurality of reference resources and the plurality of reference resources, the third model being configured to generate respective third parameters of the plurality of local features of the multimedia resource in a process of predicting the category of the multimedia resource, and a third parameter of one local feature being configured for indicating interpretability of the local feature.

In this embodiment of this disclosure, the third model is a machine learning model of a simple structure, such as a decision tree model or a linear model. To obtain the third model having performance similar to that of the first model through training, the server can use the first target category obtained through the prediction by the first model as label information of the reference resource, and then train the third model based on the plurality of reference resources and label information of the plurality of reference resources. Both the third model and the first model are models configured to predict the category of the multimedia resource. Because the first target category is obtained through the prediction by the first model and participates in training of the third model, the trained third model is a model approximate to the first model.

The server determines the respective third parameters of the plurality of local features through the trained third model, and can interpret the target category obtained by the first model based on the plurality of local features, to construct a relationship between the plurality of local features and the target category.

In some embodiments, the server can train the third model based on the first target category obtained by the first model by predicting the reference resource and a second target category obtained by the third model by predicting the reference resource. Correspondingly, for any one of the reference resources, the server determines the second target category of the reference resource based on the third model; determines a training loss of the third model based on the first target category of the reference resource and the second target category of the reference resource, the training loss being configured for indicating a difference between the first target category and the second target category; and updates a model parameter of the third model based on the training loss. The third model can predict a category of the inputted multimedia resource, and the server can predict an inputted reference resource based on the third model, to obtain the second target category of the reference resource. Because the first target category is the label information of the reference resource, and is configured for indicating a real category of the reference resource, the server can determine the training loss of the third model based on the second target category and the first target category. The training loss is in positive correlation with accuracy of the third model. A smaller training loss indicates a smaller difference between the first target category and the second target category, and a higher similarity degree between the first model and the third model indicates higher accuracy of the third model. In this embodiment, the third model is trained based on a difference between the category predicted by the first model and the category predicted by the third model, so that a prediction result of the third model gradually approaches a prediction result of the first model. Further, the third model obtained through training can obtain the prediction result the same as the prediction result of the first model. Therefore, the accuracy of the third parameters of the plurality of local features obtained through the third model is high.

In some embodiments, as shown in Formula 8, the third model is a linear model with L1 regularization.

$$g ( {x}^{′} ) = {arg min}_{g ∈ G} L ( f , g , {π}_{x} ) + Ω ( g ) \qquad Formula 8$$

g(x′) represents the third model; L represents a loss function of the third model; ƒ represents the first model, g represents a linear model, and G represents a set of linear models, including all possible linear models g; Ω(g) represents complexity of the linear model g; and πₓ represents a similarity degree between the reference resource and the multimedia resource.

In this embodiment of this disclosure, the process of training the third model is implemented by performing operations 302 to 304. In this embodiment, because the plurality of reference resources are generated based on the plurality of local features of the multimedia resource, the reference resources are similar to the multimedia resource; and because both the third model and the first model obtained through training are configured to predict a category, the third model is a model approximate to the first model. In this way, the category of the multimedia resource can be more accurately predicted based on the third model, so that in a category prediction process of the third model, a generated third parameter of a local feature is high in accuracy.

In this embodiment of this disclosure, because the third parameter is configured for indicating interpretability of a local feature, the third parameter can also be referred to as “interpretability”. Because the third model is configured to predict a third parameter, the third model can also be referred to as an “interpretable model”.

305: The server determines respective third parameters of the plurality of local features based on the third model, a third parameter of one local feature being configured for indicating interpretability of the local feature.

In this embodiment of this disclosure, a third model obtained through training is locally similar to the first model, and the third model can interpret a processing process and processing basis of obtaining the target category by the first model based on the multimedia resource. Therefore, the server can process the plurality of local features of the multimedia resource based on the trained third model, to obtain the respective third parameters of the plurality of local features. Each third parameter is configured for indicating interpretability of a local feature. A larger third parameter of a local feature indicates higher interpretability of the local feature, and therefore, the processing process of obtaining the target category by the first model based on a local feature with the higher interpretability is easier to be interpreted. This can improve interpretability of the first model.

In some embodiments, the server inputs the plurality of local features into the third model, and the third model generates the respective third parameters of the plurality of local features in the process of predicting the category of the multimedia resource based on the plurality of local features.

306: The server determines respective rules of the plurality of local features based on the plurality of local features and the target category, and determines a fourth parameter of each rule based on the respective rules of the plurality of local features, the rule being a rule configured for determining a category of the multimedia resource including the local features as the target category, and a fourth parameter of one rule being configured for indicating a credibility of the rule.

In this embodiment of this disclosure, the server can generate, based on the plurality of local features and the target category of the multimedia resource, a plurality of interpretable rules in one-to-one correspondence with the plurality of local features. In some embodiments, each rule includes a condition part and a conclusion part that are usually represented in a form of “if-then”. The condition part is “if the multimedia resource includes a local feature”, and the conclusion part is “then the category of the multimedia resource is the target category”. Using an example in which the multimedia resource is a face image, if a target category of the face image is “happy”, a rule of the first model may be that “if the face image includes a local feature of raising corners of the mouth, the category of the face image is happy”. The server can determine, based on credibility of the rule, whether the first model determines the category of the face image including the local feature “raising corners of the mouth” as “happy” is correct. The server determines a fourth parameter of the rule. A larger fourth parameter indicates that determining the category of the multimedia resource of the local feature corresponding to the rule as the target category is more likely to be accurate. A smaller fourth parameter indicates that determining the category of the multimedia resource of the local feature corresponding to the rule as the target category is more likely to be inaccurate. The server can convert the first model into a group of interpretable rules by performing rule extraction on the first model, so that a user can better understand a decision-making process of obtaining the target category by the first model, to improve reliability of the first model.

A fourth parameter of a rule of each local feature indicates credibility of the rule. In other words, the fourth parameter indicates the credibility of the rule in a current category prediction process. In other words, the fourth parameter indicates whether the rule is reliable in the current prediction process. In other words, the fourth parameter indicates whether a prediction result obtained by using the rule is accurate.

In some embodiments, the server can determine a fourth parameter of a rule based on a fifth parameter of a local feature corresponding to the rule. Correspondingly, the server extracts a plurality of rules from a rule set of the first model based on the plurality of local features and the target category; and determines, for any one of the rules, a fourth parameter of the rule based on a fifth parameter of a local feature corresponding to the rule. The fifth parameter is configured for indicating a degree of membership of the local feature to the multimedia resource, and the fourth parameter is a parameter in positive correlation with the fifth parameter. The server can extract the plurality of rules from the rule set of the first model based on the plurality of local features and the target category. Each rule includes a condition part and a conclusion part, the condition part includes the local feature of the multimedia resource, and the conclusion part includes the target category determined by the first model for the multimedia resource. The server can determine, by determining the fifth parameter of a local feature in the condition part, a degree of membership of the local feature to the multimedia resource, that is, a degree of association between the local feature and the multimedia resource, for example, indicating a proportion of the local feature in the multimedia resource. After obtaining the fifth parameter, the server determines a parameter in positive correlation with the fifth parameter as the fourth parameter. For example, the fifth parameter is used as the fourth parameter. Alternatively, a product of the fifth parameter and a preset proportion is determined as the fourth parameter. In this embodiment, the respective rules of the plurality of local features are determined, so that the first model is converted into the plurality of rules in one-to-one correspondence with the plurality of local features, to facilitate interpretation and analysis on the first model. In addition, a fourth parameter is determined based on a fifth parameter of each rule. Because the fifth parameter indicates a degree of membership of a local feature to the multimedia resource, accuracy of the determined fourth parameter is high.

In this embodiment of this disclosure, because the fourth parameter indicates a credibility of a rule, the fourth parameter can also be referred to as “confidence”. Because the fifth parameter indicates a degree of membership of a local feature to the multimedia resource, the fifth parameter can also be referred to as a “membership degree”.

307: The server performs, for any one of the local features, weighted summation on a second parameter and a third parameter of the local feature, and a fourth parameter corresponding to the local feature, to obtain a first parameter of the local feature, and the first parameter being configured for indicating a degree of contribution of the local feature to the target category.

In this embodiment of this disclosure, the second parameter is configured for indicating an importance degree of a local feature to the target category, the third parameter is configured for indicating interpretability of a local feature, and the fourth parameter of a rule is configured for indicating credibility of the rule, that is, credibility of determining the category of the multimedia resource including the local feature corresponding to the rule as the target category. For any one of the local features, the server can obtain the first parameter of the local feature by performing the weighted summation on the second parameter and the third parameter of the local feature and the fourth parameter of the rule of the local feature. The server analyzes a plurality of first parameters of the plurality of local features, and the local feature based on which the first model obtains the target category based on the multimedia resource can be determined.

A larger first parameter indicates a larger degree of contribution of the local feature to the target category, in other words, a larger first parameter indicates greater impact of the local feature when the first model obtains the target category. Therefore, by analyzing the respective first parameters of the plurality of local features, it may be determined that a local feature with a larger first parameter is a feature based on which the first model obtains the target category based on the multimedia resource, and a local feature with a smaller first parameter is not a local feature based on which the first model obtains the target category based on the multimedia resource. This helps the user learn a decision-making basis based on which the first model obtains the target category.

In this embodiment of this disclosure, a process of determining the respective first parameters of the plurality of local features based on the plurality of local features and the target category of the multimedia resource is implemented by performing operation 301 and operations 305 to 307. The second parameter represents an importance degree of a local feature to the target category, the third parameter represents interpretability of a local feature, and the fourth parameter represents a credibility of a rule of a local feature. The importance degree may be considered as a basic degree of contribution of the local feature to a prediction result. On this basis, the interpretability of the local feature and the credibility of the rule are combined, to achieve integration of multidimensional interpretability information, so that the degree of contribution obtained is more accurate.

308: For any one of the local features in the plurality of local features, the server constructs an initial path of the local feature, a starting point of the initial path being configured for representing the local feature, and an end point of the initial path being configured for representing the target category.

In this embodiment of this disclosure, for any one of the local features, the server can determine the initial path of the local feature based on the local feature and the target category. The initial path includes a plurality of nodes, and adjacent nodes in the plurality of nodes are connected by edges. For any one of the nodes, an adjacent node of the node is a node in the plurality of nodes that is closest to the node. The server can set initial values for the plurality of nodes by initializing the plurality of nodes in the initial path. For any one of the nodes other than a starting point, an initial value of the node represents a distance between the starting point of the initial path and the node. An initial value of the starting point is 0, and an initial value of another node is infinity.

309: The server performs a relaxation operation on the initial path, to obtain a path of the local feature, the path being configured for representing a processing process of obtaining the target category based on the local feature.

In some embodiments, in a process of performing the relaxation operation on the initial path, the server can perform the relaxation operation on all edges that are in the initial path and that are configured to connect the nodes. For an edge configured to connect a node u and a node v in the initial path, when a sum of an initial value of the node u and a weight value of the edge is less than an initial value of the node v, the server updates the initial value of the node v to the sum of the initial value of the node u and the weight value of the edge. When a sum of an initial value of the node u and a weight value of the edge is not less than an initial value of the node v, the server does not change the initial value of the node v. After performing the foregoing processing on all the edges in the initial path, the server can obtain a path of the local feature. An end point and a starting point of the path are consistent with the initial path. The path is configured for representing a processing process of obtaining the target category by the first model based on the local feature. A length of the path can be configured for reflecting complexity of the processing process of obtaining the target category by the first model based on the local feature. A longer path indicates a more complex process of obtaining the target category through a series of processing by the first model based on the local feature represented by the starting point in the path, that is, a lower probability of determining by the first model the category of the multimedia resource including the local feature as the target category. The server can learn, by analyzing the paths of the plurality of local features, a processing process of a predicted category obtained by the first model based on different local features, and can determine, by the lengths of the plurality of paths, the complexity of a plurality of processing processes of the target category obtained based on the plurality of local features, so that a path having a shortest length and a simplest processing process can be determined as a most critical path in the first model, so as to further optimize an internal processing process of the first model. A shorter path of the local feature indicates a simpler processing process of obtaining the target category based on the local feature. Because the first model usually obtains the target category based on the simplest processing process, a probability of obtaining the target category by the first model based on the local feature is larger.

In this embodiment of this disclosure, the path of the local feature is a path in which no negative feedback loop exists. In some embodiments, the foregoing process of performing, by the server, a relaxation operation on the initial path, to obtain a path of the local feature includes the following operations: The server performs the relaxation operation on the initial path, to obtain a first path; the server uses the first path as the path of the local feature when there is no negative feedback loop in the first path; or the server performs the relaxation operation on the initial path again when a negative feedback loop exists in the first path, to obtain a second path; and the server uses the second path as the path of the local feature when there is no negative feedback loop in the second path.

In this embodiment of this disclosure, after performing the relaxation operation on all the edges in the initial path, the server needs to check an obtained path. For an edge used to connect the node u and the node v in the path, when a sum of a value of the node u and the weight value of the edge is less than a value of the node v, it indicates that there is a negative feedback loop in the path, and the path is unavailable. In this case, the server can perform the relaxation operation on the initial path of the local feature again until there is no negative feedback loop in an obtained path.

In this embodiment of this disclosure, a plurality of intermediate nodes exist between the starting point and the end point of the initial path. A shortest path between the starting point and the end point can be obtained through the relaxation operation, and only the shortest path can represent the processing process of obtaining the target category based on the local feature, to ensure accuracy of the path.

310: The server generates model interpretability information of the first model based on the respective first parameters and paths of the plurality of local features, the model interpretability information being configured for interpreting a process of obtaining the target category by the first model based on the multimedia resource.

In this embodiment of this disclosure, the server can determine, based on degrees of contribution, indicated by the plurality of first parameters, of the plurality of local features to the target category, a probability of obtaining the target category by the first model based on any one of the local features. The server can determine, based on a processing process of the target category obtained by the first model based on the plurality of local features represented by the plurality of paths, an internal processing process of the target category obtained by the first model based on the local feature. Therefore, the server can generate the model interpretability information of the first model based on the plurality of first parameters and the plurality of paths. In some embodiments, the model interpretability information is in a form of a table, a text, a picture, or the like. This is not limited in this embodiment of this disclosure. The server generates the model interpretability information of the first model, so that the process of obtaining the target category by the first model based on the multimedia resource can be interpreted, to help the user better understand a decision-making process of the first model, and improve credibility and reliability of the first model.

In some embodiments, the server can further perform accuracy evaluation, efficiency evaluation, and stability evaluation on the first model. For example, the server obtains the plurality of sample multimedia resources and a category to which each sample multimedia resource belongs, and predicts categories for the plurality of sample multimedia resources through the first model, to evaluate accuracy, efficiency, and stability of the first model. The accuracy evaluation is performed to evaluate accuracy of a prediction result of the first model. In some embodiments, the accuracy of the first model is evaluated by using a method such as cross validation. The efficiency evaluation is performed to evaluate a prediction speed and efficiency of the first model. In some embodiments, the efficiency of the first model is evaluated by using an indicator such as inference time of the first model. The stability evaluation is performed to evaluate performance stability of the first model in different types of multimedia resources and application scenarios. In some embodiments, the stability of the first model is evaluated by using an indicator such as a generalization capability of the first model. After evaluation, when performance of the first model is poor, the server can further optimize the first model by using a hyperparameter tuning technology, to improve the performance of the first model. In a process of performing hyperparameter tuning on the first model, a hyperparameter range needs to be selected first. In some embodiments, a hyperparameter includes a learning rate, a regularization parameter, a quantity of hidden layer nodes, a quantity of iterations, and the like. After the hyperparameter range is determined, a search method needs to be selected to traverse hyperparameter space. Common search methods include grid search, random search, Bayesian optimization, and the like. In a search process, an impact of each hyperparameter combination on the performance of the first model needs to be evaluated. Generally, the performance of the first model is evaluated by using a method such as cross validation. For example, indicators such as calculation of an average cross validation score and average precision. After the search is completed, an optimal hyperparameter combination needs to be selected. Common selection methods include selecting a hyperparameter combination having highest precision, selecting a hyperparameter combination having a smallest loss function, and the like. The server determines the optimal hyperparameter combination by using Formula 9.

$${min}_{θ ∈ θ} L ( X , Y , θ ) \qquad Formula 9$$

L represents a loss function of a hyperparameter combination θ; X represents an input of the first model; Y represents an output of the first model; and Θ represents the hyperparameter space.

This embodiment of this disclosure provides a model interpretability information generation method. The respective first parameters and paths of the plurality of local features are determined based on the plurality of local features and the target category of the multimedia resource. Relationships between the plurality of local features and the target category can be determined based on the degrees of contribution, indicated by the plurality of first parameters, of the plurality of local features to the predicted category, and the processing process of obtaining the target category based on the local feature can be learned based on the paths. In this way, the model interpretability information of the first model is generated based on information of a plurality of respective dimensions of the plurality of local features, and the process of obtaining the target category by the first model based on the multimedia resource can be more accurately interpreted in detail based on the model interpretability information, thereby improving the credibility and the reliability of the model interpretation.

FIG. 4 is a block diagram of a model interpretability information generation apparatus according to an embodiment of this disclosure. The apparatus is configured to perform the foregoing model interpretability information generation method. Referring to FIG. 4, the apparatus includes: a first determining module 401, a second determining module 402, and a first generation module 403.

The first determining module 401 is configured to determine respective first parameters of a plurality of local features based on the plurality of local features and a target category of a multimedia resource, the target category being obtained through prediction on the multimedia resource by a first model, the first model being configured to predict a category of an inputted multimedia resource, and a first parameter of one local feature being configured for indicating a degree of contribution of the local feature to the target category.

The second determining module 402 is configured to determine, based on a plurality of local features and a target category, respective paths of the plurality of local features, a starting point of the path of one local feature being configured for representing the local feature, an end point being configured for representing the target category, and the path being configured for representing a processing process of obtaining the target category based on the local feature.

The first generation module 403 is configured to generate model interpretability information of the first model based on the respective first parameters and paths of the plurality of local features, the model interpretability information being configured for interpreting a process of obtaining the target category by the first model based on the multimedia resource.

In some embodiments, FIG. 5 is a block diagram of another model interpretability information generation apparatus according to an embodiment of this disclosure. Referring to FIG. 5, the first determining module 401 includes:
a first determining unit 501, configured to determine, based on a second model, a plurality of second parameters of the plurality of local features, the second model being configured to predict the second parameters of the local features, and a second parameter of one local feature being configured for indicating an importance degree of the local feature to the target category;
a second determining unit 502, configured to determine a plurality of third parameters of the plurality of local features based on a third model, the third model being configured to determine the third parameters of the local feature, and a third parameter of one local feature being configured for indicating interpretability of the local feature;
a third determining unit 503, configured to determine respective rules of the plurality of local features based on the plurality of local features and the target category, and determines a fourth parameter of each rule based on the respective rules of the plurality of local features, the rule being a rule configured for determining a category of the multimedia resource including the local features as the target category, and a fourth parameter of one rule being configured for indicating a credibility of the rule; and
a summation unit 504, configured to perform, for any one of the local features, weighted summation on a second parameter and a third parameter of the local feature, and a fourth parameter corresponding to the local feature, to obtain a first parameter of the local feature.

In some embodiments, the second model includes a plurality of decision trees.

The first determining unit 501 is configured to determine, for any one of the local features of the plurality of local features, the second parameter of the local feature in each decision tree based on the second model; and an average value of the second parameters of the local feature in each decision tree is determined as the second parameter of the local feature.

In some embodiments, the third determining unit 503 is configured to extract, based on the plurality of local features and the target category, the plurality of rules from a rule set of the first model. For any one of the rules, a fourth parameter of the rule is determined based on a fifth parameter of a local feature corresponding to the rule, the fifth parameter being configured for indicating a degree of membership of the local feature to the multimedia resource, and the fourth parameter being a parameter positively correlated with the fifth parameter.

In some embodiments, still referring to FIG. 5, the apparatus further includes:
a second generation module 404, configured to generate a plurality of reference resources based on the plurality of local features, each reference resource including at least one of the local features in the plurality of local features;
a prediction module 405, configured to determine, for any one of the reference resources, a first target category of the reference resource based on a first model; and
a training module 406, configured to train the third model based on respective first target categories of the plurality of reference resources and the plurality of reference resources, the third model being configured to generate the respective third parameters of the plurality of local features of the multimedia resource in a process of predicting the category of the multimedia resource.

In some embodiments, the training module 406 is configured to determine, for any one of the reference resources, a second target category of the reference resource based on the third model; a training loss of the third model is determined based on the first target category of the reference resource and the second target category of the reference resource, the training loss being configured for indicating a difference between the first target category and the second target category; and a model parameter of the third model is updated based on the training loss.

In some embodiments, the second determining module 402 is configured to construct, for any one of the local features in the plurality of local features, an initial path of the local feature, a starting point of the initial path being configured for representing the local feature, and an end point of the initial path being configured for representing a target category; and a relaxation operation is performed on the initial path, to obtain a path of the local feature.

This embodiment of this disclosure provides a model interpretability information generation apparatus. The respective first parameters and paths of the plurality of local features are determined based on the plurality of local features and the target category of the multimedia resource. Relationships between the plurality of local features and the target category can be determined based on the degrees of contribution, indicated by the plurality of first parameters, of the plurality of local features to the predicted category, and the processing process of obtaining the target category based on the local feature can be learned based on the paths. In this way, the model interpretability information of the first model is generated based on information of a plurality of respective dimensions of the plurality of local features, and the process of obtaining the target category by the first model based on the multimedia resource can be more accurately interpreted in detail based on the model interpretability information, thereby improving the credibility and the reliability of the first model.

The model interpretability information generation apparatus provided in the foregoing embodiments is described by using division of functional modules described above only as an example. In actual applications, the functions described above can be allocated to and completed by different functional modules according to requirements, in other words, an internal structure of a terminal is divided into different functional modules, so as to complete all or a part of the functions described above. In addition, the model interpretability information generation apparatus provided in the foregoing embodiments is based on the same concept as the model interpretability information generation method in the foregoing embodiments. For a specific implementation process, refer to the method embodiments, and the details are not described herein again.

In this embodiment of this disclosure, a computer device can be configured as a terminal or a server. When the computer device is configured as a server, the server is used as an execution body to implement technical solutions provided in the embodiments of this disclosure. When the computer device is configured as a terminal, the terminal is used as an execution body to implement the technical solutions provided in this embodiment of this disclosure. The technical solutions provided in this embodiment of this disclosure can alternatively be cooperatively implemented by the server and the terminal. This is not limited in this embodiment of this disclosure.

FIG. 6 is a structural block diagram of a terminal 600 according to an embodiment of this disclosure.

The terminal 600 includes: a processor 601 and a memory 602.

Processing circuitry, such as the processor 601, includes one or more processing cores, for example, a 4-core processor or an 8-core processor. The processor 601 is implemented by using at least one hardware form of a digital signal processing (DSP), a field-programmable gate array (FPGA), or a programmable logic array (PLC). The processor 601 also includes a main processor and a coprocessor. The main processor is a processor configured to process data in a wake-up state, and is also referred to as a central processing unit (CPU). The coprocessor is a low-power processor configured to process data in a standby state. In some embodiments, the processor 601 is integrated with a graphics processing unit (GPU), and the GPU is configured to be responsible for rendering and drawing content that needs to be displayed on a display screen. In some embodiments, the processor 601 further includes an artificial intelligence (AI) processor. The AI processor is configured to process a calculation operation related to machine learning.

The memory 602 includes one or more computer-readable storage media, and the computer-readable storage medium is non-transient or non-transitory for example. The memory 602 further includes a high-speed random access memory, and a non-volatile memory such as one or more disk storage devices and flash memory storage devices. In some embodiments, a non-transient computer-readable storage medium in the memory 602 is configured to store at least one computer program. The at least one computer program is configured for being executed by the processor 601 to implement the model interpretability information generation method provided in the method embodiments of this disclosure.

In some embodiments, the terminal 600 may further include: a peripheral device interface 603, and at least one peripheral device. The processor 601, the memory 602, and the peripheral device interface 603 are connected to each other by using a bus or a signal line. The peripheral devices are connected to the peripheral device interface 603 by using the bus, the signal line, or a circuit board. Specifically, the peripheral device includes at least one of a radio frequency circuit 604, a display screen 605, a camera assembly 606, an audio circuit 607, and a power supply 608.

The peripheral device interface 603 may be configured to connect at least one peripheral device related to input/output (I/O) to the processor 601 and the memory 602. In some embodiments, the processor 601, the memory 602, and the peripheral device interface 603 are integrated on the same chip or circuit board. In some other embodiments, any one or two of the processor 601, the memory 602, and the peripheral device interface 603 are implemented on an independent chip or circuit board. This is not limited in this embodiment.

The radio frequency circuit 604 is configured to receive and transmit a radio frequency (RF) signal, and the radio frequency signal is also referred to as an electromagnetic signal. The radio frequency circuit 604 communicates with a communication network and other communication devices by using the electromagnetic signal. The radio frequency circuit 604 converts an electric signal into the electromagnetic signal for transmitting, or converts a received electromagnetic signal into the electric signal. In some embodiments, the radio frequency circuit 604 includes: an antenna system, a radio frequency transceiver, one or more amplifiers, a tuner, an oscillator, a digital signal processor, an encoding and decoding chipset, a subscriber identity module card, and the like. The radio frequency circuit 604 communicates with other terminals by using at least one wireless communication protocol. The wireless communication protocol includes but is not limited to: a world wide web, a metropolitan area network, an intranet, generations of mobile communication networks (2G, 3G, 4G, and 5G), a wireless local area network and/or a Wi-Fi network. In some embodiments, the radio frequency circuit 604 further includes a circuit related to near field communication (NFC). This is not limited in this disclosure.

The display screen 605 is configured to display a user interface (UI). The UI includes a graph, text, an icon, a video, and any combination thereof. When the display screen 605 is a touchscreen, the display screen 605 further has a capability of collecting a touch signal on or above the surface of the display screen 605. The touch signal is inputted into the processor 601 as a control signal for processing. In this case, the display screen 605 is further configured to provide a virtual button and/or a virtual keyboard, also referred to as a soft button and/or a soft keyboard. In some embodiments, there is one display screen 605 that is disposed on a front panel of the terminal 600. In some other embodiments, there are at least two display screens 605 that are respectively disposed on different surfaces of the terminal 600 or in a folded design. In some other embodiments, the display screen 605 is a flexible display screen and is disposed on a curved surface or a folded surface of the terminal 600. Even, the display screen 605 is further set in a non-rectangular irregular graph, namely, a special-shaped screen. The display screen 605 is manufactured by using a material such as a liquid crystal display (LCD) or an organic light-emitting diode (OLED).

The camera assembly 606 is configured to collect an image or a video. In some embodiments, the camera assembly 606 includes a front-facing camera and a rear-facing camera. Generally, the front-facing camera is disposed on the front panel of the terminal, and the rear-facing camera is disposed on a back of the terminal. In some embodiments, at least two rear-facing cameras are arranged, which are respectively any one of a main camera, a depth-of-field camera, a wide-angle camera, and a telephoto camera, to achieve a background blurring function through fusion of the main camera and the depth-of-field camera, achieve a panoramic photographing function and a virtual reality (VR) photographing function through fusion of the main camera and the wide-angle camera, or achieve other fusion photographing functions. In some embodiments, the camera assembly 606 further includes a flash. The flash is a single color temperature flash or a dual color temperature flash. The dual color temperature flash refers to a combination of a warm light flash and a cool light flash, and is configured to compensate light in different color temperatures.

The audio circuit 607 includes a microphone and a speaker. The microphone is configured to collect sound waves of a user and an environment, convert the sound waves into the electric signal, and input the electric signal into the processor 601 for processing, or input the electric signal into the radio frequency circuit 604 for implementing speech communication. For the purpose of stereo collection or noise reduction, there is a plurality of microphones respectively disposed at different parts of the terminal 600. The microphone is further a microphone array or an omnidirectional microphone. The speaker is configured to convert the electric signal from the processor 601 or the radio frequency circuit 604 into the sound wave. The speaker is a conventional thin-film speaker or a piezoelectric ceramics speaker. When the speaker is a piezoelectric ceramics speaker, the speaker can not only convert the electrical signal into a sound wave that can be heard by humans, but also convert the electric signal into a sound wave that cannot be heard by humans, for a purpose such as ranging. In some embodiments, the audio circuit 607 further includes an earphone jack.

The power supply 608 is configured to supply power to components in the terminal 600. The power supply 608 is an alternating current, a direct current, a primary battery, or a rechargeable battery. When the power supply 608 includes the rechargeable battery, the rechargeable battery is a wired rechargeable battery or a wireless rechargeable battery. The wired rechargeable battery is a battery charged through a wired circuit, and the wireless rechargeable battery is a battery charged through a wireless coil. The rechargeable battery is further configured to support a fast charge technology.

In some embodiments, the terminal 600 further includes one or more sensors 609. The one or more sensors 609 include, but are not limited to: an acceleration sensor 610, a gyroscope sensor 611, a pressure sensor 612, an optical sensor 613, and a proximity sensor 614.

The acceleration sensor 610 detects magnitude of accelerations on three coordinate axes of a coordinate system established by the terminal 600. For example, the acceleration sensor 610 is configured to detect components of a gravitational acceleration on the three coordinate axes. The processor 601 controls, according to a gravitational acceleration signal collected by the acceleration sensor 610, the display screen 605 to display the user interface in a landscape mode or a portrait mode. The acceleration sensor 610 is further configured to collect motion data of a game or a user.

The gyroscope sensor 611 detects a body direction and a rotation angle of the terminal 600, the gyroscope sensor 611 and the acceleration sensor 610 cooperating to collect a 3D action of the user on the terminal 600. The processor 611 implements the following functions according to data collected by the gyroscope sensor 611: motion sensing (for example, change the UI based on a tilt operation of the user), image stabilization during photographing, game control, and inertial navigation.

The pressure sensor 612 is disposed on a side border frame of the terminal 600 and/or a lower layer of the display screen 605. When disposed on the side border frame of the terminal 600, the pressure sensor 612 detects a holding signal of the user on the terminal 600, and the processor 601 performs left/right hand recognition or a shortcut operation according to the holding signal collected by the pressure sensor 612. When the pressure sensor 612 is disposed at the lower layer of the display screen 605, the processor 601 controls an operable control on the UI interface according to a pressure operation of the user on the display screen 605. The operable control includes at least one of a button control, a scroll-bar control, an icon control, and a menu control.

The optical sensor 613 is configured to collect an ambient light intensity. In an embodiment, the processor 601 controls display brightness of the display screen 605 according to the ambient light intensity collected by the optical sensor 613. Specifically, when the ambient light intensity is relatively high, the display brightness of the display screen 605 is increased; when the ambient light intensity is relatively low, the display brightness of the display screen 605 is decreased. In another embodiment, the processor 601 further dynamically adjusts a photographing parameter of the camera assembly 606 according to the ambient light intensity collected by the optical sensor 613.

The proximity sensor 614 is also referred to as a distance sensor, and is generally disposed on the front panel of the terminal 600. The proximity sensor 614 is configured to collect a distance between the user and the front surface of the terminal 600. In an embodiment, when the proximity sensor 614 detects that the distance between the user and the front surface of the terminal 600 gradually becomes smaller, the processor 601 controls the display screen 605 to switch from a screen-on state to a screen-off state; when the proximity sensor 604 detects that the distance between the user and the front surface of the terminal 600 gradually becomes larger, the processor 601 controls the display screen 605 to switch from the screen-off state to the screen-on state.

A person skilled in the art can understand that the structure shown in FIG. 6 does not constitute a limitation to the terminal 600, and the terminal 600 can include more or fewer components than those shown in the figure, or some components can be combined, or a different component deployment can be used.

FIG. 7 is a schematic structural diagram of a server according to an embodiment of this disclosure. A server 700 may vary greatly because of different configurations or performance, and includes one or more central processing units (CPU) 701 and one or more memories 702. The memory 702 stores at least one computer program. The at least one computer program is loaded and executed by the processor 701 to implement the model interpretability information generation method provided in the foregoing method embodiments. The server further includes components such as a wired or wireless network interface, a keyboard, and an input/output interface, to facilitate input and output. The server further includes other components configured to implement a function of a device. Details are not described herein again.

An embodiment of this disclosure further provides a computer-readable storage medium, the computer-readable storage medium being configured to store at least one computer program, and the at least one computer program being loaded and executed by a processor to implement the model interpretability information generation method in the foregoing embodiments. For example, the computer-readable storage medium is a read-only memory (ROM), a random access memory (RAM), a compact disc read-only memory (CD-ROM), a tape, a floppy disk, a light data storage device, and the like.

An embodiment of this disclosure further provides a computer program product, including a computer program product. The computer program product is executed by a processor to implement the model interpretability information generation method in the foregoing embodiments.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

A person of ordinary skill in the art can understand that all or a part of the steps of the foregoing embodiments can be implemented by using hardware, or can be implemented by a program instructing relevant hardware. The program is stored in a computer-readable storage medium. The storage medium described above is a read-only memory, a magnetic disk, an optical disc, or the like.

The above mentioned descriptions are merely examples of embodiments of this disclosure, and are not intended to limit this disclosure. Any modification, equivalent replacement, or improvement made without departing from the spirit and principle of this disclosure falls within the protection scope of this disclosure.

What is claimed is:

1. A model interpretability information generation method, comprising:
determining respective first parameters of a plurality of local features based on the plurality of local features and a target category of a multimedia resource, the target category being obtained through prediction on the multimedia resource by a first model, and the first parameters indicating degrees of contribution of the plurality of local features to the target category;
determining respective paths of the plurality of local features based on the plurality of local features and the target category, a starting point of a path of a local feature of the plurality of local features representing the local feature, an end point representing the target category, and the path representing a processing process of obtaining the target category based on the local feature; and
generating, based on the respective first parameters and the paths of the plurality of local features, model interpretability information of a process of obtaining the target category by the first model based on the multimedia resource.

2. The method according to claim 1, further comprising:
determining respective second parameters of the plurality of local features based on a second model, the second model being configured to predict the second parameters of the local features, and the second parameters indicating importance degrees of the plurality of local features to the target category;
determining respective third parameters of the plurality of local features based on a third model, the third model being configured to determine the third parameters of the local features, and the third parameters indicating interpretation information of the plurality of local features;
determining respective rules of the plurality of local features based on the plurality of local features and the target category;
determining fourth parameters based on the respective rules of the plurality of local features, the rules being for determining a category of the multimedia resource comprising the local features as the target category, and the fourth parameters indicating credibility of the respective rules; and
performing, for a local feature of the plurality of local features, weighted summation on a second parameter and a third parameter of the local feature, and a fourth parameter corresponding to the local feature, to obtain the first parameter of the local feature.

3. The method according to claim 2, wherein
the second model includes a plurality of decision trees; and
the determining the respective second parameters comprises:
determining, for the local feature of the plurality of local features, second parameters of the local feature in a plurality of decision trees based on the second model; and
determining an average value of the second parameters of the local feature in the plurality of decision trees as the second parameter of the local feature.

4. The method according to claim 2, wherein
the determining the respective rules comprises:
extracting the respective rules of the plurality of local features from a rule set of the first model based on the plurality of local features and the target category; and
the determining the fourth parameter comprises:
determining the rule of the local feature of the plurality of local features based on a fifth parameter of the local feature corresponding to the rule, the fifth parameter indicating a degree of membership of the local feature to the multimedia resource, and the fourth parameter being positively correlated with the fifth parameter.

5. The method according to claim 2, further comprising:
generating a plurality of reference resources based on the plurality of local features, each reference resource including at least one of the plurality of local features;
determining, for each of the plurality of reference resources, a first target category of the respective reference resource based on the first model; and
training the third model based on the respective first target categories of the plurality of reference resources and the plurality of reference resources, the third model being configured to generate the respective third parameters of the plurality of local features in a process of predicting the category of the multimedia resource.

6. The method according to claim 5, wherein the training the third model comprises:
determining a second target category of the reference resource of the plurality of reference resources based on the third model;
determining a training loss of the third model based on the first target category of the reference resource and the second target category of the reference resource, the training loss indicating a difference between the first target category and the second target category; and
updating a model parameter of the third model based on the training loss.

7. The method according to claim 1, wherein the determining the respective paths of the plurality of local features comprises:
constructing an initial path of the local feature of the plurality of local features, a starting point of the initial path representing the local feature, and an end point of the initial path representing the target category; and
performing a relaxation operation on the initial path, to obtain the path of the local feature.

8. An information processing apparatus, comprising:
processing circuitry configured to:
determine respective first parameters of a plurality of local features based on the plurality of local features and a target category of a multimedia resource, the target category being obtained through prediction on the multimedia resource by a first model, and the first parameters indicating degrees of contribution of the plurality of local features to the target category;
determine respective paths of the plurality of local features based on the plurality of local features and the target category, a starting point of a path of a local feature of the plurality of local features representing the local feature, an end point representing the target category, and the path representing a processing process of obtaining the target category based on the local feature; and
generate, based on the respective first parameters and the paths of the plurality of local features, model interpretability information of a process of obtaining the target category by the first model based on the multimedia resource.

9. The information processing apparatus according to claim 8, wherein the processing circuitry is configured to:
determine respective second parameters of the plurality of local features based on a second model, the second model being configured to predict the second parameters of the local features, and the second parameters indicating importance degrees of the plurality of local features to the target category;
determine respective third parameters of the plurality of local features based on a third model, the third model being configured to determine the third parameters of the local features, and the third parameters indicating interpretation information of the plurality of local features;
determine respective rules of the plurality of local features based on the plurality of local features and the target category;
determine fourth parameters based on the respective rules of the plurality of local features, the rules being for determining a category of the multimedia resource comprising the local features as the target category, and the fourth parameters indicating credibility of the respective rules; and
perform, for a local feature of the plurality of local features, weighted summation on a second parameter and a third parameter of the local feature, and a fourth parameter corresponding to the local feature, to obtain the first parameter of the local feature.

10. The information processing apparatus according to claim 9, wherein
the second model includes a plurality of decision trees; and
the processing circuitry is configured to:
determine, for the local feature of the plurality of local features, second parameters of the local feature in a plurality of decision trees based on the second model; and
determine an average value of the second parameters of the local feature in the plurality of decision trees as the second parameter of the local feature.

11. The information processing apparatus according to claim 9, wherein the processing circuitry configured to:
extract the respective rules of the plurality of local features from a rule set of the first model based on the plurality of local features and the target category; and
determine the rule of the local feature of the plurality of local features based on a fifth parameter of the local feature corresponding to the rule, the fifth parameter indicating a degree of membership of the local feature to the multimedia resource, and the fourth parameter being positively correlated with the fifth parameter.

12. The information processing apparatus according to claim 9, wherein the processing circuitry configured to:
generate a plurality of reference resources based on the plurality of local features, each reference resource including at least one of the plurality of local features;
determine, for each of the plurality of reference resources, a first target category of the respective reference resource based on the first model; and
train the third model based on the respective first target categories of the plurality of reference resources and the plurality of reference resources, the third model being configured to generate the respective third parameters of the plurality of local features in a process of predicting the category of the multimedia resource.

13. The information processing apparatus according to claim 12, wherein the third model is trained by:
determining a second target category of the reference resource of the plurality of reference resources based on the third model;
determining a training loss of the third model based on the first target category of the reference resource and the second target category of the reference resource, the training loss indicating a difference between the first target category and the second target category; and
updating a model parameter of the third model based on the training loss.

14. The information processing apparatus according to claim 8, wherein the processing circuitry configured to:
construct an initial path of the local feature of the plurality of local features, a starting point of the initial path representing the local feature, and an end point of the initial path representing the target category; and
perform a relaxation operation on the initial path, to obtain the path of the local feature.

15. A non-transitory computer-readable storage medium storing instructions which when executed by a processor cause the processor to perform:
determining respective first parameters of a plurality of local features based on the plurality of local features and a target category of a multimedia resource, the target category being obtained through prediction on the multimedia resource by a first model, and the first parameters indicating degrees of contribution of the plurality of local features to the target category;
determining respective paths of the plurality of local features based on the plurality of local features and the target category, a starting point of a path of a local feature of the plurality of local features representing the local feature, an end point representing the target category, and the path representing a processing process of obtaining the target category based on the local feature; and
generating, based on the respective first parameters and the paths of the plurality of local features, model interpretability information of a process of obtaining the target category by the first model based on the multimedia resource.

16. The non-transitory computer-readable storage medium according to claim 15, wherein the instructions when executed by the processor further cause the processor to perform:
determining respective second parameters of the plurality of local features based on a second model, the second model being configured to predict the second parameters of the local features, and the second parameters indicating importance degrees of the plurality of local features to the target category;
determining respective third parameters of the plurality of local features based on a third model, the third model being configured to determine the third parameters of the local features, and the third parameters indicating interpretation information of the plurality of local features;
determining respective rules of the plurality of local features based on the plurality of local features and the target category;
determining fourth parameters based on the respective rules of the plurality of local features, the rules being for determining a category of the multimedia resource comprising the local features as the target category, and the fourth parameters indicating credibility of the respective rules; and
performing, for a local feature of the plurality of local features, weighted summation on a second parameter and a third parameter of the local feature, and a fourth parameter corresponding to the local feature, to obtain the first parameter of the local feature.

17. The non-transitory computer-readable storage medium according to claim 16, wherein
the second model includes a plurality of decision trees; and
the determining the respective second parameters comprises:
determining, for the local feature of the plurality of local features, second parameters of the local feature in a plurality of decision trees based on the second model; and
determining an average value of the second parameters of the local feature in the plurality of decision trees as the second parameter of the local feature.

18. The non-transitory computer-readable storage medium according to claim 16, wherein
the determining the respective rules comprises:
extracting the respective rules of the plurality of local features from a rule set of the first model based on the plurality of local features and the target category; and
the determining the fourth parameter comprises:
determining the rule of the local feature of the plurality of local features based on a fifth parameter of the local feature corresponding to the rule, the fifth parameter indicating a degree of membership of the local feature to the multimedia resource, and the fourth parameter being positively correlated with the fifth parameter.

19. The non-transitory computer-readable storage medium according to claim 16, wherein the instructions when executed by the processor further cause the processor to perform:
generating a plurality of reference resources based on the plurality of local features, each reference resource including at least one of the plurality of local features;
determining, for each of the plurality of reference resources, a first target category of the respective reference resource based on the first model; and
training the third model based on the respective first target categories of the plurality of reference resources and the plurality of reference resources, the third model being configured to generate the respective third parameters of the plurality of local features in a process of predicting the category of the multimedia resource.

20. The non-transitory computer-readable storage medium according to claim 19, wherein the training the third model comprises:
determining a second target category of the reference resource of the plurality of reference resources based on the third model;
determining a training loss of the third model based on the first target category of the reference resource and the second target category of the reference resource, the training loss indicating a difference between the first target category and the second target category; and
updating a model parameter of the third model based on the training loss.
